(19) United States
(12) Patent Application Publication
(10) Pub. No.: US 2008/0172502 A1
(43) Pub. Date: Jul. 17, 2008

(54) PORTABLE COMPUTER

(75) Inventor: Chi-Yu Wu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/838,231

(22) Filed: Aug. 14, 2007

(30) Foreign Application Priority Data
Jan. 16, 2007 (TW) 96101564

(51) Int. Cl. G06F 13/14

(52) U.S. Cl. 710/33

(57) ABSTRACT

A portable computer is provided. The portable computer includes a motherboard, a first display, a second display, a non-volatile memory device, and a microprocessor, wherein the motherboard includes an audio circuit. When the motherboard is shut down and the microprocessor receives a playing command, the microprocessor enables the audio circuit and plays specific multimedia stored in the non-volatile memory device through the audio circuit and the second display device according to the playing command.

### CROSS-REFERENCE TO RELATED APPLICATION

This application claims the priority benefit of Taiwan application serial no. 96101564, filed Jan. 16, 2007. All disclosure of the Taiwan application is incorporated herein by reference.

### BACKGROUND OF THE INVENTION

1. Field of the Invention

The invention relates to a portable computer and, more particularly, to a portable computer which can play multimedia in a system off state.

2. Description of Related Art

Along with increasing demands of people about functions of portable computers, the design technology of portable computers is to change with each passing day. Therefore, portable computers with various functions have been developed. For example, a previous portable computer with a single display, which is in an off state, can play multimedia data, such as a music CD, without being started up. However, along with the higher and higher demands of a user, a portable computer which can only play a CD in an off state gradually not meets with the demands of the user. Therefore, some manufacturers also begin to make a second operating system built-in a hard disk. When the main system of a portable computer is in an off state, a user can start up the second operating system hidden in the hard disk through another switch for playing multimedia data stored in the hard disk, or a CD, VCD, DVD, etc.

However, the above method for playing multimedia has a great drawback that when the second operating system is started up for playing multimedia, the second operating system can also start up a motherboard, a display, an audio circuit, a display circuit, a central processing unit, and so on, at the same time. The second operating system only needs to play multimedia, therefore the motherboard, the display circuit and the central processing unit are not operated in the highest efficiency state; however, power consumption is still considerable.

Microsoft Corporation recently develops a configuration disclosed in U.S. Pat. No. 7,152,171B2 and a new operating system, Windows Vista, according to the configuration, and along with the operating system, many portable computer manufacturers also develop a future generation of portable computers. The feature of the portable computers is that both surfaces of their lids have a display, respectively. Microsoft Corporation has also done something which also includes a multimedia application, in the operating system for supporting this kind of portable computer. Mostly, in an on state, the portable computer, without opening its lid, can play multimedia stored in a hard disk or an optical storage medium. Therefore, a big display under the lid of the computer needs not to be used, and power consumption can be reduced. However, this mode still plays multimedia only in the on state of the portable computer, that is to say, the central processing unit, the hard disk, the motherboard and other peripheral circuits of the portable computer are still in an operating state. In this way, much unnecessary power consumption still exist, and therefore, affects the endurance of a battery.

### BRIEF SUMMARY OF THE INVENTION

An objective of the invention is to provide a portable computer and a method for playing multimedia, so that specific multimedia can be selected from a second display and played when a motherboard is in an off state.

To achieve the above or other objectives, the invention provides a portable computer. The portable computer includes a motherboard, a first display, a second display, a non-volatile memory device, and a microprocessor. The motherboard includes an audio circuit. The first display is coupled to the motherboard. The non-volatile memory device stores multimedia data. The microprocessor is coupled to the second display and the non-volatile memory device, and it enables the audio circuit and plays specific multimedia stored in the non-volatile memory device when the motherboard is in an off state and the microprocessor receives a playing command.

In one embodiment of the invention, the microprocessor of the above portable computer enables the audio circuit through a general purpose input output (GPIO) interface.

Considering from another aspect, the invention further provides a method for playing multimedia. The method includes the following steps. A portable computer is provided, which includes a motherboard, a first display, a non-volatile memory device, and a second display, wherein the motherboard includes an audio circuit. When the motherboard and the first display are in an off state and a playing command is received, specific multimedia is gotten from the non-volatile memory device based on the playing command, and then the audio circuit is enabled, and finally, the specific multimedia is played through the second display and the audio circuit.

Because the embodiment of the invention adopts a configuration that the microprocessor is coupled to the second display and the non-volatile memory device, the second display may show the multimedia stored in the non-volatile memory device in a list when the motherboard and the first display are in the off state. Through the list, a user may select specific multimedia for playing. According to the playing command, the microprocessor gets the specific multimedia from the non-volatile memory device and starts up the audio circuit for playing sound. Meanwhile, the microprocessor can also make the second display show specific multimedia information. Therefore, the portable computer in the embodiments of the invention can play multimedia, improve the drawback of electricity consumption in prior art, and prolong playing time and save electricity at the same time.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a block diagram showing the circuit of the portable computer according to one embodiment of the invention.

FIG. 2 is a block diagram showing the circuit of the portable computer according to another embodiment of the invention.

FIG. 3 is a block diagram showing the circuit of the portable computer according to another embodiment of the invention.

FIG. 4 is a flow chart showing steps of a method for playing multimedia according to another embodiment of the invention.

### DETAILED DESCRIPTION OF THE INVENTION

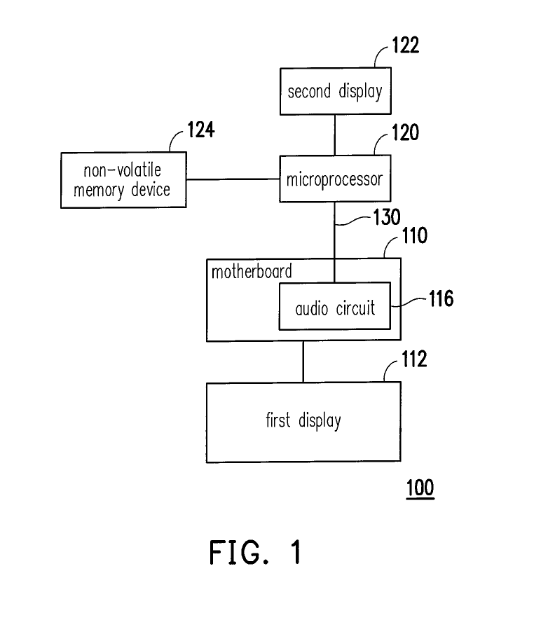

FIG. 1 is a block diagram showing the circuit of the portable computer according to one embodiment of the invention. Referring to FIG. 1, the portable computer 100 includes a motherboard 110, a first display 112, a second display 122, a non-volatile memory device 124, and a microprocessor 120, wherein the non-volatile memory device 124 may be a most known flash memory. The motherboard 110 includes an audio circuit 116, such as an audio amplifier and a trumpet. The non-volatile memory device 124 in the embodiment stores much multimedia data, such as files of MP3, WAV, etc. The following uses the above elements for illustrating embodiments of the invention.

The above first display 112 is coupled to the motherboard 110. The microprocessor 120 is coupled to the second display 122, the non-volatile memory device 124, the motherboard 110, and the audio circuit 116, respectively. In the embodiment, the microprocessor 120, the second display 122, and the non-volatile memory device 124 can be integrated as a second display module which can be disposed on the reverse side of the first display 112 of the portable computer.

First, in normal operation, a user may deal with, such as words editing, oral reports, image processing, etc., through an operating system which is built-in the motherboard 110. However, in some circumstances, the user may only want to use the portable computer for audio-visual entertainment, for example, listening to music, therefore, the user may operate the above operating system for shutting down the above motherboard 110 and the first display 112 at this moment.

Note that, in the embodiment, the power circuit disposed on the motherboard 110 is also electrically connected to the microprocessor 120, the second display 122, and the non-volatile memory device, whereby the microprocessor 120, the second display 122, and the non-volatile memory device 124 can still normally work when the power of the motherboard 110 and the first display 112 is shut down. Therefore, the second display 122 can still show the list of multimedia and other related information when the motherboard 110 and the first display 112 mentioned above, perform a shutdown action.

Next, through the list of multimedia shown on the second display 122, the user may look for a multimedia file that he wants to play. Send a playing command to the microprocessor 120 when the user finds the specific multimedia file that he wants to play. After receiving the playing command, the microprocessor 120 enables and starts up the audio circuit 16 built-in the motherboard 110 through the general purpose input output (GPIO) interface 130, so that the specific multimedia stored in the non-volatile memory device 124 is played.

Referring to the above embodiment, persons having ordinary skill in the art may appreciate that the multimedia playing mode in the embodiment only needs to start up the audio circuit 116 rather than the whole circuit on the motherboard 110. Therefore, utilizing the circuit in the above embodiment can avoid unnecessary power consumption and effectively prolong the endurance of a battery.

In addition, because the non-volatile memory device 124 in FIG. 1 is applied to the portable computer 100, its characteristics about small volume, large capacity, light weight, non-volatility, shakeproof performance, and so on, must be considered, and its preferred embodiment is to adopt a nand flash memory. Therefore, the non-volatile memory device 124, if utilizing the nand flash memory, can act as a medium for storing much multimedia data. In addition, when power supplying is off, the user needs not to worry about losing data stored in the nand flash memory.

Note that, in the above embodiment, the display configuration of the portable computer 100 utilizes double displays that a first display 112 is a big display shown when the lid is opened, and a second display 122 being parallel to the first display 112 is disposed on the other surface of the lid, which surface external housing is in when the lid is closed. Because work content shown on the second display 122 is simpler and more brief than that shown on the first display 112, the length/width size of the second display 122 is much smaller than that of the first display 112, for example, the second display 122 may utilize a penetration liquid crystal panel.

Furthermore, the portable computer 100 can also play music in an off state in addition to supporting windows vista operating system in an on state. When the lid of the portable computer 100 is closed and the motherboard 110 is in the off state, the user can start up the microprocessor 120. The smaller second display 122 shows related operating menu and multimedia information, and the first display 112 does not show pictures.

Referring to the above embodiment, persons having ordinary skill in the art can carry out components in the above embodiment according to the following way. For example, the second display 112 utilizes a 2.8 inches liquid crystal display; the first display 112 utilizes a 12.1 inches liquid crystal display. The second display 122 can utilize a smaller liquid crystal display because of only showing some simple operating information; therefore, utilizing the second display 122 can save more electricity energy than utilizing the bigger first display 112, so that electricity consumption of the portable computer 100 can remarkably drop.

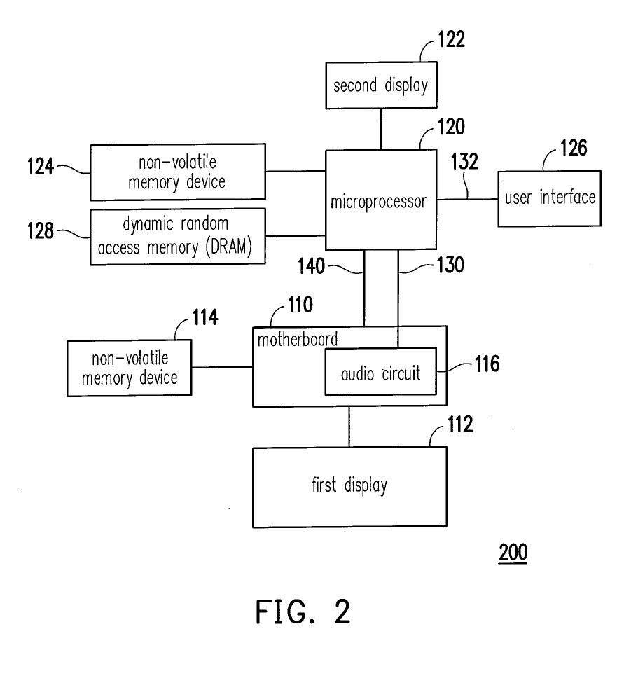

FIG. 2 is a block diagram showing the circuit of the portable computer according to another embodiment of the invention. Referring to FIGS. 1 and 2 at the same time, the difference between the portable computer 200 in FIG. 2 and the portable computer 100 in FIG. 1 is that the portable computer 200 includes a dynamic random access memory (DRAM) 128, a user interface 126, and a non-volatile memory device 114 coupled to the motherboard, additionally. The following illustrates the embodiment of the invention using the above elements.

Generally speaking, the non-volatile memory device 114 may be a hard disk with high capacity or a popular plug and play memory device. The microprocessor 120 is coupled to the motherboard 110 through a universal serial bus (USB) 140 through which the microprocessor 120 can get data from the motherboard 110. Much multimedia data stored in the non-volatile memory device 114 can be quickly transmitted and stored in the non-volatile memory device 124 through the above USB 140 and the microprocessor 120, when the portable computer 200 is in an on state. The advantage of transmitting multimedia data to the non-volatile memory device through the USB 140 in the on state is that the user can play music or sound that he wants to listen to when the portable computer 200 is in the off state. Therefore, it is unnecessary to start up the motherboard, the central processing unit, and the peripheral hard disk first as the past, for getting the multimedia data stored in the hard disk.

As mentioned above, the user interface 126 in FIG. 2 is coupled to the microprocessor 120 through the GPIO interface 132. In this embodiment, the user interface 126 may be, for example, multiple functional optional keys for providing an operating interface, and when it is cooperated with functional options shown on the second display 122, the user can intuitively select the song list stored in the non-volatile memory device 124. In other embodiments, the user interface 126 may also be a control panel. When a shown functional option is selected and enabled, a playing command is produced and transmitted to the microprocessor 120 which starts up the audio circuit 116 according to the playing command. Therefore, when the portable computer 200 is in the off state, if the user wants to play music, he can operate the user interface 126, watch the specific multimedia shown on the second display 122, and look for some specific multimedia stored in the non-volatile memory device 124, so that he can easily find the specific multimedia. Because user's selecting specific multimedia without the auxiliary of the second display 122 before is like to look for a needle in a haystack, playing the specific multimedia may be easier when the question looking for files for playing multimedia in an off state can be solved.

In addition, the efficiency of the DRAM 128 is to temporarily store working data of the microprocessor 120, and to avoid reading data too slowly for the unsteady system caused by the portable computer 200 which is used in a shaky environment. For example, during movement or unsteady operation on a knee, the DRAM 128 temporarily stores specific multimedia for playing, and this makes playing multimedia be much fluent.

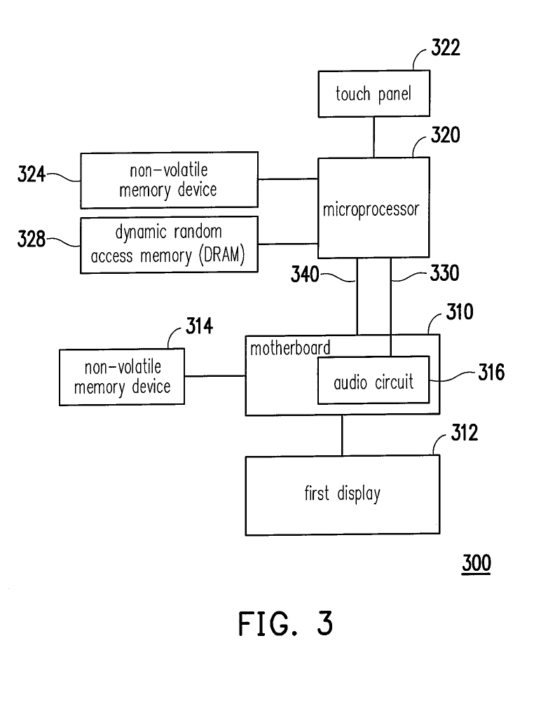

Note that, in the embodiment of the invention, the second display and the user interface can be combined in some application circumstances. FIG. 3 is a block diagram showing the circuit of the portable computer according to another embodiment of the invention. Referring to FIGS. 2 and 3, the difference between the portable computer 300 in FIG. 3 and the portable computer 200 in FIG. 2 is that the portable computer 300 utilizes a touch panel 322 instead of the original second display 122, that is to combine functions of the user interface 126 and the second display 122 in FIG. 2, therefore, a user can do operation and selection on the functional option shown on the second display 322, directly. Other circuit blocks of the embodiment have been shown in FIGS. 1 and 2; therefore, they are not described here.

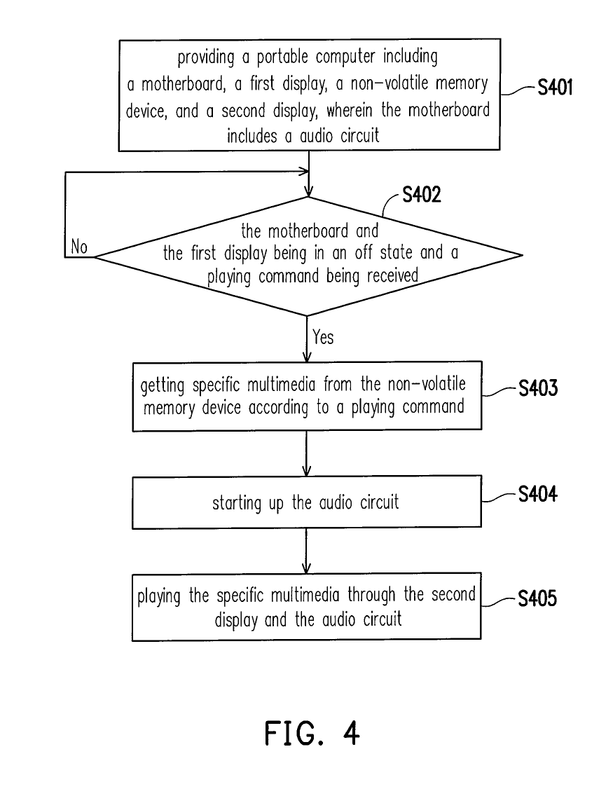

To sum the above embodiments up, spirit of the invention can be illustrated as the following method steps. FIG. 4 is a flow chart showing steps of the method for playing multimedia according to another embodiment of the invention. Referring to FIG. 4, the proceeding steps of the method are shown as follows: first, providing a portable computer including a motherboard, a first display and a second display, wherein the motherboard includes a audio circuit (step S401); next, judging whether the motherboard and the first display are in the off state and a playing command is received (step S402); getting specific multimedia from a non-volatile memory device according to the playing command, if the motherboard and the first display are in the off state and the playing command is received (step S403); then, starting up the audio circuit (step S404); finally, playing the specific multimedia through the second display and the audio circuit (step S405).

To sum up, because the embodiments of the invention adopt the configuration that the microprocessor is coupled to the second display and the non-volatile memory device, when the motherboard and the first display is in the off state, the microprocessor can get specific multimedia stored in the non-volatile memory device and start up the audio circuit for playing sound according to a playing command. Meanwhile, the microprocessor can also make the second display show information of the specific multimedia. Therefore, the portable computer in the embodiments of the invention can easily play and select the specific multimedia, improve the drawback of electricity consumption in prior art, and prolong playing time and save electricity at the same time.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A portable computer, comprising:
a motherboard comprising an audio circuit;
a first display coupled to the motherboard;
a second display;
a non-volatile memory device storing multimedia data, and
a microprocessor coupled to the second display and the non-volatile memory device, enabling the audio circuit and playing specific multimedia stored in the non-volatile memory device when the motherboard is in an off state and the microprocessor receives a playing command.

2. The portable computer according to claim 1, wherein the microprocessor enables the audio circuit through a first general purpose input output (GPIO) interface.

3. The portable computer according to claim 1, wherein the portable computer further comprises a user interface providing an operating interface for a user.

4. The portable computer according to claim 1, wherein when the microprocessor plays the specific multimedia, the second display shows information of the specific multimedia.

5. The portable computer according to claim 1, wherein the portable computer further comprises a dynamic random access memory (DRAM) for temporarily storing working data of the microprocessor.

6. The portable computer according to claim 1, wherein the length/width size of the second display is smaller than that of the first display.

7. The portable computer according to claim 1, wherein the microprocessor is coupled to the motherboard through a universal serial bus (USB).

8. The portable computer according to claim 1, wherein the second display may be a touch panel.

9. The portable computer according to claim 3, wherein the operating interface of the user interface corresponds to functional option shown on the second display.

10. The portable computer according to claim 3, wherein the user interface is coupled to the microprocessor through a second GPIO interface.

11. The portable computer according to claim 3, wherein the user interface may be a control panel.

12. The portable computer according to claim 8, wherein the touch panel provides an operating interface for selecting functional option.

13. The portable computer according to claim 9, wherein the playing command is transmitted to the microprocessor when the functional option is enabled.

14. The portable computer according to claim 12, wherein the playing command is transmitted to the microprocessor when the functional option is enabled.

15. A method for playing multimedia, the method comprising:
providing a portable computer comprising a motherboard, a first display, a non-volatile memory device, and a second display, wherein the motherboard comprises an audio circuit; and
receiving a playing command under the motherboard and the first display are in the off state;
getting specific multimedia from the non-volatile memory device based on the playing command;
enabling up the audio circuit; and
playing the specific multimedia through the second display and the audio circuit.
